(19) United States
(12) Patent Application Publication
(10) Pub. No.: US 2017/0001619 A1
(43) Pub. Date: Jan. 5, 2017

(54) Hoverbarrow and method

(71) Applicant: Mark Welker, Dallas, TX (US)

(72) Inventor: Mark Welker, Dallas, TX (US)

(21) Appl. No.: 14/545,870

(22) Filed: Jun. 30, 2015

(51) Int. Cl. B60V 3/02; B60P 1/64; B60V 1/00

(52) U.S. Cl. CPC B60V 3/025; B60V 1/00; B60P 1/6445

(57) ABSTRACT

A hoverbarrow apparatus is provided to mechanically lift objects to be transported using a cushion of turbulent air as the force providing the lift. The air cushion methods of lift drastically reduce the physical exertion necessary for motion, forward or reverse, required to perform the task of transporting objects. The air cushion further improves the performance and use of the barrow by allowing the barrow to float on turbulent air over objects in its path significantly reducing or eliminating impressions and divots in the surface currently associated with the present wheelbarrow technology.

### CROSS REFERENCE TO RELATED APPLICATIONS

The present application claims the priority and the benefit of the U.S. Provisional Patent Application of Mark Welker bearing Ser. No. 60/630,289, filed Dec. 8, 2011, the entirety of which is incorporated herein by reference. Further, the present application claims the priority and the benefit of the U.S. Patent Application of Mark Welker bearing Ser. No. 13/694,513, filed Dec. 8, 2012, the entirety of which is incorporated herein by reference.

### TECHNICAL FIELD

The present disclosure relates to the field of lifting devices, systems and methods. More particularly, the present disclosure relates to a hover-type lifting device, system, and method.

### BACKGROUND

The usefulness of wheelbarrows is well known. Such uses are in a wide variety of applications such as by way of example construction, gardening, and other uses where loads are moved and transported form one place to another. The wheelbarrow is a unique tool in that due to its single wheel design a relatively heavy load may be balanced and moved. Wheelbarrows are also useful in that they may be used to move loads over rough and difficult terrain where other means of transport would be very difficult.

Currently, wheelbarrows by design perform their function of transporting objects of disproportional weight from one point to another using lifting and pushing techniques that are considered difficult by most individuals. The current wheelbarrow design has not changed from the original design of having a wheel or roller that is mounted forward of a container bed and handles opposite the wheel from the container. The design is to hold objects between the wheel and the handles for transporting purposes.

With a fixed wheel mounted forward of the container section, and grasping handles extending several feet behind the back of the wheelbarrow, an individual must lift upwards on the handles using leverage to lift any disproportional weight needed to be transported. The ability to lift loads is based on the individual's body strength for obtaining the objective of moving the load.

Additionally, after upward lift has been achieved the individual must then exert forward or reverse force to overcome the total weight of the objects placed within the container before the wheelbarrow will move in the desired direction. Further, physical exertion must be applied by the individual when either pushing or pulling the wheelbarrow over any objects that maybe laying in its path as obstructing movement of the wheel, thus further increasing the negativity of current use.

Moreover, under weighted conditions the wheel itself can cause divots or impressions in the ground damaging the surface which the wheelbarrow passes over should that surface be unstable.

Generally, pushing a loaded wheelbarrow typically presents challenges related to force and leverage. Force generated by a user to propel a wheelbarrow is typically transmitted from a user's shoulders, down through the user's arms and hands, to wheelbarrow handles. The user's arms therefore act as levers to amplify force required to propel the wheelbarrow, the amplified force being transmitted to the user's shoulders. Similarly, the user's lower arms can act as levers to amplify force on the user's upper arms. As a result, the user's arms, shoulders, and upper torso experience loads and concomitant stresses that are considerably greater than forces applied at the wheelbarrow handles.

Many attempts have been made to power or motorize wheelbarrows by using gasoline-powered engines in order to propel the wheelbarrow and its load. However, such wheelbarrows end up being bulky, cumbersome, and difficult to use. In some cases such wheelbarrows can be dangerous to use in many types of terrain. Further, such wheelbarrows tend to be excessively heavy and unbalanced requiring the user to shift and manipulate the load to compensate for the load and the terrain.

Hover devices have been unsuccessfully implemented as small-scale lifting devices because reducing the size of such devices loses economies of scale. Further, it is readily known how critical it is to avoid excessive turbulence generated around objects, such as airplanes, trucks, bridges and equipment. It is commonly known and appreciated that excessive turbulence can make the interaction between the fluid and the object inefficient and difficult to control. Avoiding turbulence is a major factor in aerodynamic design.

There exists, therefore, a need for a powered or motorized wheelbarrow solving the aforementioned problems is desired.

A feature of the present disclosure is to provide a modular transporting apparatus adapted for accepting multiple accessories.

Another feature of the present disclosure is to provide a lifting platform in connection with a rack arrangement for accepting interchangeably different containers adapted for different uses, such as by way of example, gardening, construction, beach, sports, etc.

Another feature of the present disclosure is to provide a lifting platform in connection with various interchangeable handles, such as by way of example, a two-hand handle as associated with a typical wheelbarrow, a single bar handle as associated with a lawn mower, and a pulling handle as associated with a wagon.

Another feature of the present disclosure is to provide a lifting platform in connection with various outriggers for keeping the lifting platform stable, such as by way of example, skid-type out riggers, skid outriggers with one or more wheels, tank outriggers with a continuous articulated metal track, etc.

Yet another feature of the present disclosure is to provide a lifting platform that has a locking mechanism for preventing unauthorized use, such as by way of example, a key, a keypad, etc.

Yet still another feature of the present disclosure is to provide a lifting platform that has a power device for powering a fluid mover, such as by way of example, battery, gas, electricity, etc.

Yet still another feature of the present disclosure is to provide a lifting platform that can be remotely operated as a drone.

Another feature of the present disclosure is to provide a lifting platform that is compact in design having the ability to collapse the container or carrying portion.

Another feature of the present disclosure is to provide a lifting platform that is adapted for carrying a solid load, a sludge load or a liquid load, and where needed using various and sundry liners in the container.

Yet another feature of the present disclosure is to provide a lifting platform that no longer needs leverage to lift.

Yet still another feature of the present disclosure is to provide a lifting platform that has a pivoting bucket with a pull-type handle.

Yet still another feature of the present disclosure is to provide a lifting platform that has auxiliary wheels adapted for spanning a ramp or stairs.

And yet still another feature of the present disclosure is to provide a lifting platform that is weighted appropriately for enhancing the unloading of the load in the container.

Another feature of the present disclosure is to provide a lifting platform that enhances the aerodynamic design by changing the flow characteristics of a driving or lifting fluid.

Still another feature of the present disclosure is to provide a lifting platform that accepts a driving or lifting fluid and initiates a turbulent flow in the fluid to create or enhance the lifting characteristics of the platform.

While certain exemplary embodiments have been described in details and shown in the accompanying drawings, it is to be understood that such embodiments are merely illustrative of and not devised without departing from the basic scope thereof, which is determined by the claims that follow.

### BRIEF DESCRIPTION OF THE DRAWINGS

The accompanying drawings, which are incorporated in and constitute a part of this specification, illustrate an implementation of apparatus consistent with the present disclosure and, together with the detailed description, serve to explain advantages and principles consistent with the disclosure.

FIG. 1 illustrates one embodiment of a hoverbarrow apparatus of the disclosure of the present application similar to a wheelbarrow-type device and having a single skirt configuration.

FIG. 2 illustrates the embodiment of the hoverbarrow apparatus of the disclosure of the present application as illustrated in FIG. 1 with the cover removed.

FIG. 3 is a perspective, lower view of one embodiment of a skirt for a hoverbarrow apparatus of the disclosure of the present application.

FIG. 4 is a cross-sectional view of the perspective, lower view of the embodiment of the skirt for a hoverbarrow apparatus of the disclosure of the present application as illustrated in FIG. 3.

FIG. 5 is a shaded-sectional view of the perspective view of the embodiment of the skirt for a hoverbarrow apparatus of the disclosure of the present application as illustrated in FIG. 3.

FIG. 6 illustrates another embodiment of a hoverbarrow apparatus of the disclosure of the present application similar to a wheelbarrow-type device and having a double skirt configuration.

FIG. 7 is a perspective, upper view of one embodiment of a double skirt configuration for the hoverbarrow apparatus of the disclosure of the present application as illustrated in FIG. 6.

FIG. 8 is a perspective, lower view of the embodiment of the double skirt configuration for the hoverbarrow apparatus of the disclosure of the present application as illustrated in FIG. 6.

FIG. 9 illustrates a bottom plan view of yet another embodiment of a hoverbarrow apparatus of the disclosure of the present application similar to a wheelbarrow-type device and having a peripheral skirt configuration.

FIG. 10 illustrates an elevation view the another embodiment of a hoverbarrow apparatus of the disclosure of the present application similar to a wheelbarrow-type device and having a peripheral skirt configuration as illustrated in FIG. 9.

FIG. 11 illustrates a cut-away, blown-up view of a portion of the illustration of the another embodiment of a hoverbarrow apparatus of the disclosure of the present application similar to a wheelbarrow-type device and having a peripheral skirt configuration as illustrated in FIGS. 10.

FIG. 12 is a flow diagram illustrating one method of the present disclosure.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF EMBODIMENTS

To achieve the foregoing objects, features, and advantages and in accordance with the purpose of the invention as embodied and broadly described herein, a hoverbarrow apparatus and method are provided.

The use of an alternate method for performing the laborious task of transporting heavy material or objects can be achieved with the use of a hoverbarrow apparatus. The hoverbarrow apparatus mechanically lifts the objects to be transported using a cushion of air as the main means of lift. The air cushion method of lift drastically reduces the physical exertion necessary for forward or reverse motion required to perform the task of transporting objects.

The air cushion further improves the performance and use of the barrow by allowing the barrow to float over objects in its path significantly reducing or eliminating impressions and divots in the surface currently associated with the present wheelbarrow technology.

Fluid flow can be divided into three types: laminar, transitional, and turbulent. Simplistically, turbulent flow occurs when the fluid is flowing fast, laminar flow when the fluid is flowing slowly, and transitional flow when the fluid is flowing between the turbulent state and the laminar state. But this is not always the case.

Turbulent flow is fluid flow, in a gas or liquid, in which the fluid undergoes irregular fluctuations, or mixing, in contrast to laminar flow, in which the fluid moves in smooth paths or layers. In turbulent flow the speed of the fluid at a point is continuously undergoing changes in both magnitude and direction. The flow of wind and rivers is generally turbulent, even though the currents are gentle. The air or water swirls and eddies are created while its overall bulk moves along a specific direction.

Turbulence is defined as of, relating to, or denoting flow of a fluid in which the velocity at any point fluctuates irregularly and there is continual mixing rather than a steady or laminar flow pattern. Thus, turbulence is chaotic or unstable eddying motion in a fluid. In laminar flow, the motion of the particles of fluid is very orderly with all particles moving in straight lines parallel to the pipe walls. In turbulent flow, the particles move in a rotating motion.

The transition from laminar to turbulent flow depends upon the value of a mathematical quantity equal to the average velocity of flow in a conduit times the diameter of the conduit times the mass density of the fluid divided by its absolute viscosity. This mathematical quantity, a pure number without dimensions, is known as the Reynolds number and is applied to other types of flow that are completely enclosed or that involve a moving object completely immersed in a fluid.

Thus, velocity is just one of the factors that affects the flow of a fluid. The Reynolds number defines a relationship between the primary fluid factors of density, diameter of the pipe, and velocity. Typically it has been found, if the Reynolds number is less than approximately 2,000 then the flow is laminar, if the Reynolds number is greater than approximately 4,000 then the flow is turbulent, and if the Reynolds number is between 2,000 and 4,000 the flow is transitional.

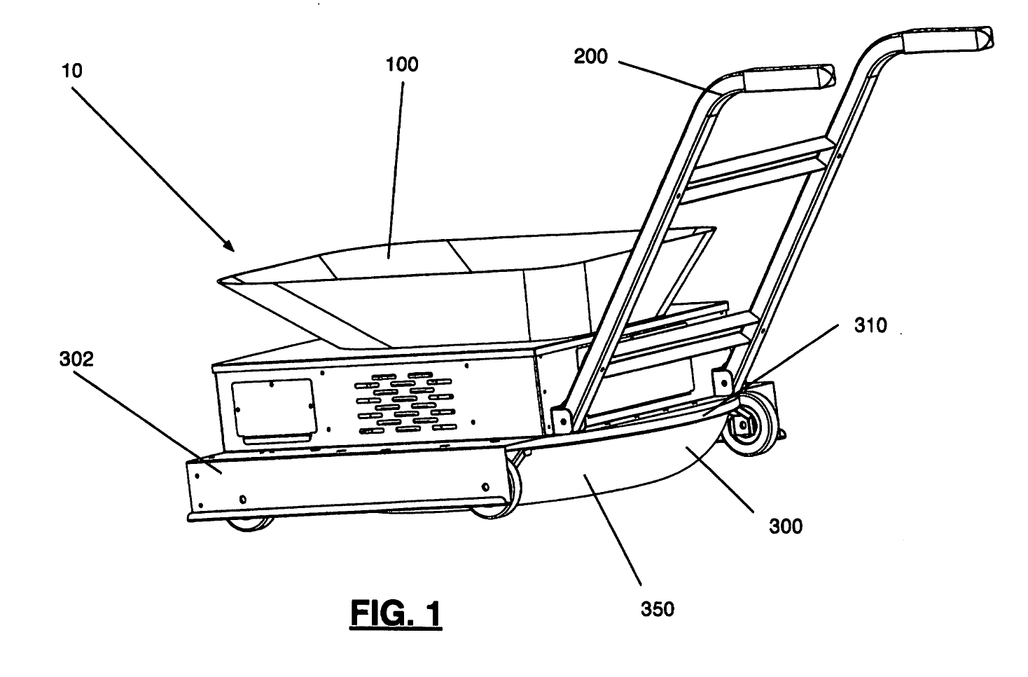

FIG. 1 illustrates one embodiment of a hoverbarrow apparatus 10 of the disclosure of the present application similar to a wheelbarrow-type device and having a single skirt configuration.

FIG. 1 illustrates the hoverbarrow apparatus 10 includes generally a container 100, a handle 200 and a lifting platform 300. Also, the hoverbarrow apparatus 10 is shown with a cover 302 around the lifting platform 300. The lifting platform 300 is shown with a torus member 350 attached to a plate member 310.

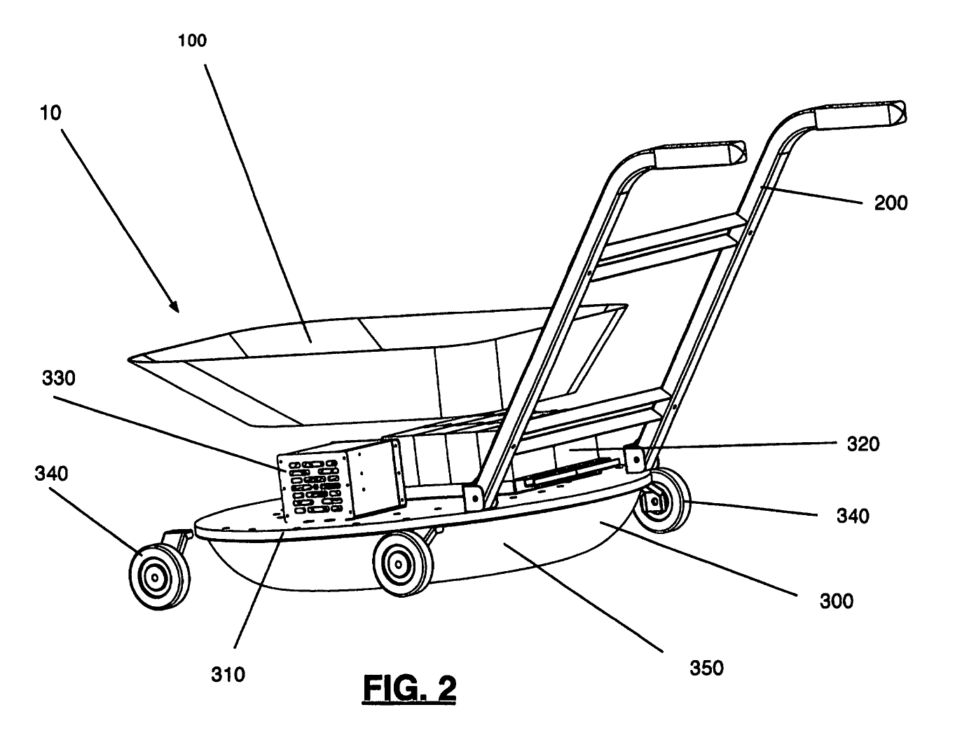

FIG. 2 illustrates the embodiment of the hoverbarrow apparatus 10 of the disclosure of the present application as illustrated in FIG. 1 with the cover 302 removed.

FIG. 2 illustrates the hoverbarrow apparatus 10 includes generally a container 100, a handle 200 and a lifting platform 300. The lifting platform 300 is shown with a torus member 350, batteries 320, and fluid mover/fan 330 attached to the plate member 310. Also illustrated are the outrigger/wheels 340.

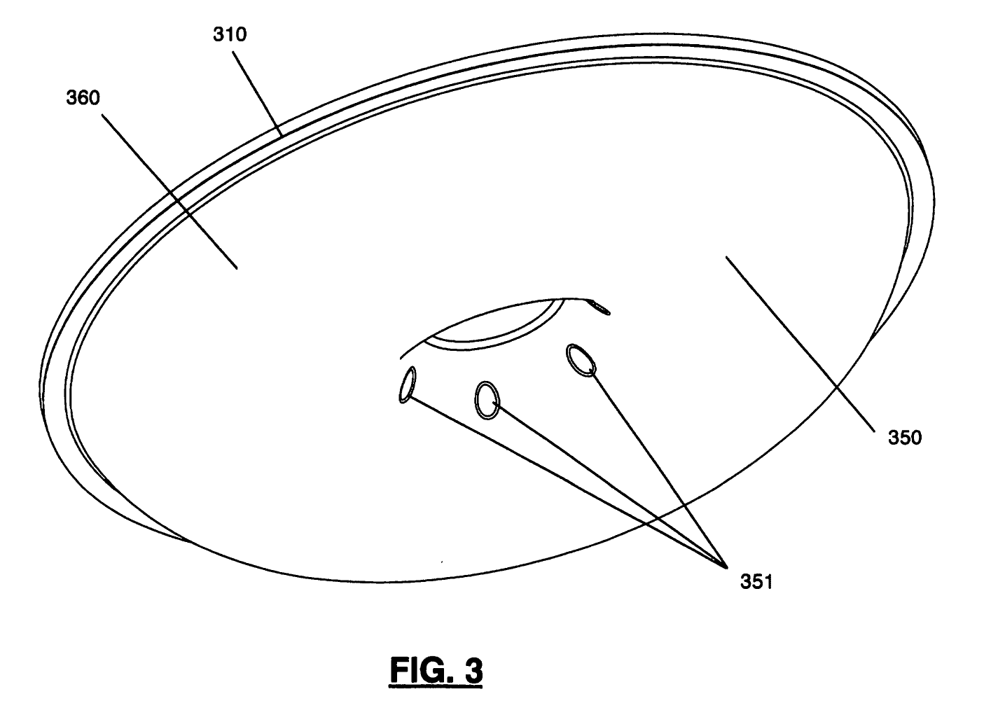

FIG. 3 is a perspective, lower view of one embodiment of a skirt 360 for a hoverbarrow apparatus of the disclosure of the present application. The skirt 360 comprises a plate member 310 with the torus member 350 attached. The torus member 350 has at least one aperture 351 along the interior annulus 354. The at least one aperture 351 is designed as a “trip” for the fluid. As the fluid passes through the aperture 351, the trip causes the flow to go from a laminar state to a turbulent state or from a transitional state to a turbulent state. The trip aperture 351, as shown in FIG. 3, has a beveled, knife-like edge. It is appreciated by those skilled in the art that various and sundry types of trips can be used to initiate turbulent flow, and any trip used to initiate turbulent flow or the use of turbulent flow is within the scope of the present disclosure.

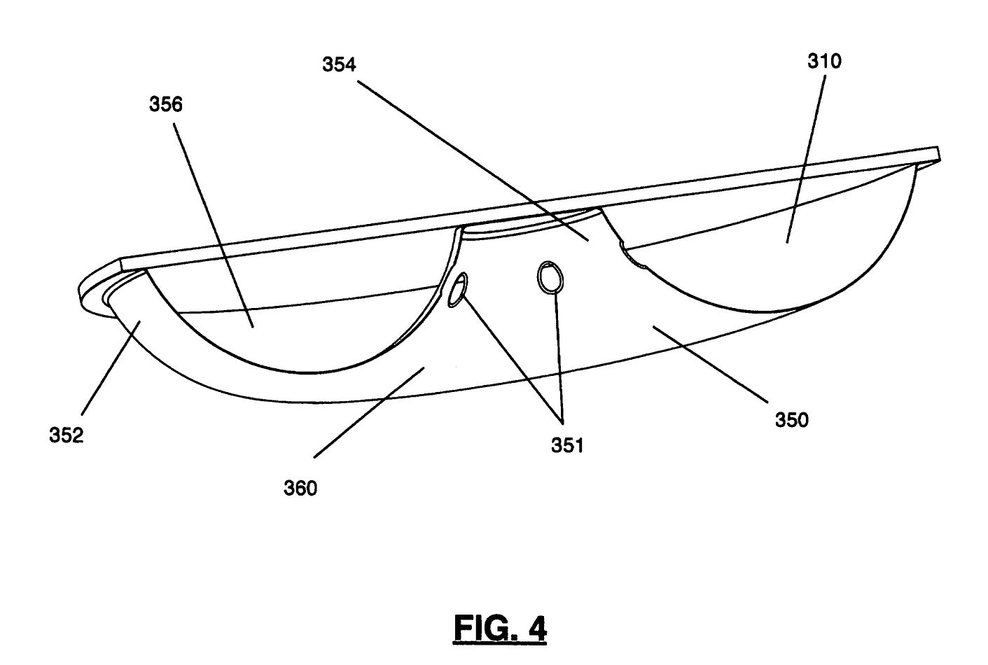

FIG. 4 is a cross-sectional view of the perspective, lower view of the embodiment of the skirt 360 for a hoverbarrow apparatus of the disclosure of the present application as illustrated in FIG. 2. The skirt 360 includes a torus member 350 attached to the plate member 310. The torus member 350 has at least one aperture 351 along the interior annulus 354. Further, the torus member 350 has an exterior annulus 352 and an interior annulus 354. The plate member 310 and the torus member 350 define a volume 356. The trip aperture 351, as shown in FIG. 4, has a serrated edge. As the fluid passes through the trip aperture 351, the trip causes the flow to go from a laminar state to a turbulent state or from a transitional state to a turbulent state.

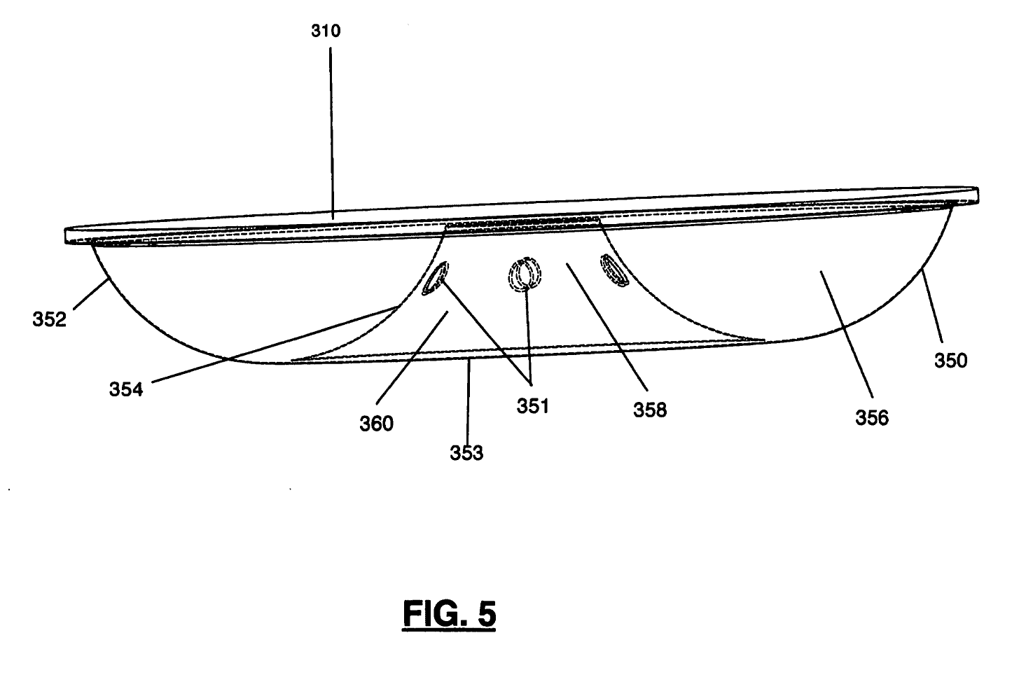

FIG. 5 is a shaded-sectional view of the perspective view of the embodiment of the skirt 360 for a hoverbarrow apparatus of the disclosure of the present application as illustrated in FIG. 2. The skirt 360 includes a torus member 350 attached to the plate member 310. The torus member 350 has at least one aperture 351 along the interior annulus 354. Further, the torus member 350 has an exterior annulus 352 and an interior annulus 354. The plate member 310 and the torus member 350 define a volume 356. As stated above, the at least one aperture 351 is designed as a “trip” for the fluid. As the fluid passes through the aperture 351, the trip causes the flow to go from a laminar state to a turbulent state or from a transitional state to a turbulent state. The trip aperture 351, as shown in FIG. 5, comprises a double orifice arrangement.

Some general features that characterize turbulence are irregularity, diffusivity, rationality, and dissipation.

Irregularity is important because turbulent flows are always highly irregular. For this reason, turbulence problems are normally treated statistically rather than deterministically. Turbulent flow is chaotic. However, not all chaotic flows are turbulent.

Diffusivity is important because the readily available supply of energy in turbulent flows tends to accelerate the homogenization or the mixing of fluids. The characteristic that is responsible for the enhanced mixing and increased rates of mass, momentum and energy transports in a flow is called “diffusivity.”

Rationality is important because turbulent flows have non-zero vorticity and are characterized by a strong three-dimensional vortex generation mechanism known as vortex stretching. In fluid dynamics, they are essentially vortices subjected to stretching associated with a corresponding increase of the component of vorticity in the stretching direction—due to the conservation of angular momentum. On the other hand, vortex stretching is the core mechanism on which the turbulence energy cascade relies to establish the structure function. In general, the stretching mechanism implies thinning of the vortices in the direction perpendicular to the stretching direction due to volume conservation of fluid elements. As a result, the radial length scale of the vortices decreases and the larger flow structures break down into smaller structures. The process continues until the small-scale structures are small enough that their kinetic energy can be transformed by the fluid's molecular viscosity into heat. This is why turbulence is always rotational and three-dimensional. For example, atmospheric cyclones are rotational but their substantially two-dimensional shapes do not allow vortex generation and so are not turbulent. On the other hand, oceanic flows are dispersive but essentially non rotational and therefore are not turbulent.

Dissipation is important because to sustain turbulent flow, a persistent source of energy supply is required because turbulence dissipates rapidly as the kinetic energy is converted into internal energy by viscous shear stress.

Turbulence causes the formation of eddies of many different length scales. Most of the kinetic energy of the turbulent motion is contained in the large-scale structures. The energy “cascades” from these large-scale structures to smaller scale structures by an inertial and essentially inviscid mechanism. This cascading process continues; creating smaller and smaller scale structures which produces a hierarchy of eddies. Eventually this process creates structures that are small enough that molecular diffusion becomes important and viscous dissipation of energy finally takes place.

As illustrated in FIGS. 1-5, a barrow apparatus 10 comprising a container 100 for accepting material, a fluid mover/fan 330, and a conduit for accepting fluid from the fluid mover for systematically releasing the fluid such that the released fluid provides a film of fluid upon which the barrow apparatus moves with respect to a surface thereby the material in the container is movable to any desired location.

More particularly, the barrow apparatus 10 has at least a portion of the conduit with a ring torus shape, the torus member 350. The ring torus portion 350 of the conduit has at least one aperture (not illustrated) on the ring portion of the torus shaped member 350 through which the fluid passes causing the fluid to flow around the lowest portion of the torus member 350, the surface-engaging annulus 353, thereby providing the film of fluid on which the barrow apparatus 10 rides.

Typically, the barrow apparatus 10 uses air as the fluid. However it is appreciated that additional fluids may be advantageous in specific situations.

Also, the barrow apparatus 10 can include a stabilizer member or outrigger/wheels 340. Further, the barrow apparatus 10 comprises controls for the fluid mover/fan 330 to provide varying fluid flows for maintaining the barrow apparatus 10 above the surface over which it travels. Still further, the barrow apparatus 10 has a guide member, handle, haft, grip 200 or a combination thereof.

The barrow apparatus 10 further has a plate or planar member 310 in association with the fluid mover 330, and an inlet in the plate or planar member 310 for accepting fluid from the fluid mover 330.

A donut shaped, ring torus member 350 is provided having an interior annulus 354, an exterior annulus 352 and a curved surface-engaging annulus 353 in operative association with the surface under the barrow apparatus 10. The donut shaped, ring torus member 350 is for accepting the fluid from the inlet in the plate member 310. The plate member 310 and the donut shaped, ring torus member 350 define a volume 356. At least one aperture 351 is positioned on the inner annulus 354 of the donut shaped, ring torus member 350 for allowing the fluid to egress therefrom.

The fluid mover 330 places into motion the fluid for passage through the inlet in the planar member 310 for pressurizing the volume 356 defined by the donut shaped, ring torus member 350 and the planar member 310. The only mechanism for relieving the pressure in the volume 356 created by the moving fluid is through the at least one aperture 351 positioned on the inner annulus 354 of the donut shaped, ring torus member 350. The fluid egressing the at least one aperture 351 then pressurizes a second volume 358 defined by the exterior surface of the donut shaped, ring torus member 350 and the surface-engaging annulus 353 under the barrow apparatus 10. This creates a steady state, uniform flow of fluid out of the second volume 358 via a gap between the donut shaped, ring torus member 350 and the surface under the barrow apparatus 10. The gap is caused by the steady state flow of fluid from the second volume 358 around the curved portion of the donut shaped, ring torus member 350 adjacent to the surface for dispersion of the fluid into the atmosphere.

The planar member 310 has a surface partially defining the volume 356. The surface may be configured to create turbulent flow within the volume defined by the surface of the planar member 310 and the donut shaped, ring torus member 350. Typically, the planar member 310 would be roughened to create the turbulence. However, it is appreciated that there are other ways if initiating turbulence in a flow of fluid, such as, a trip.

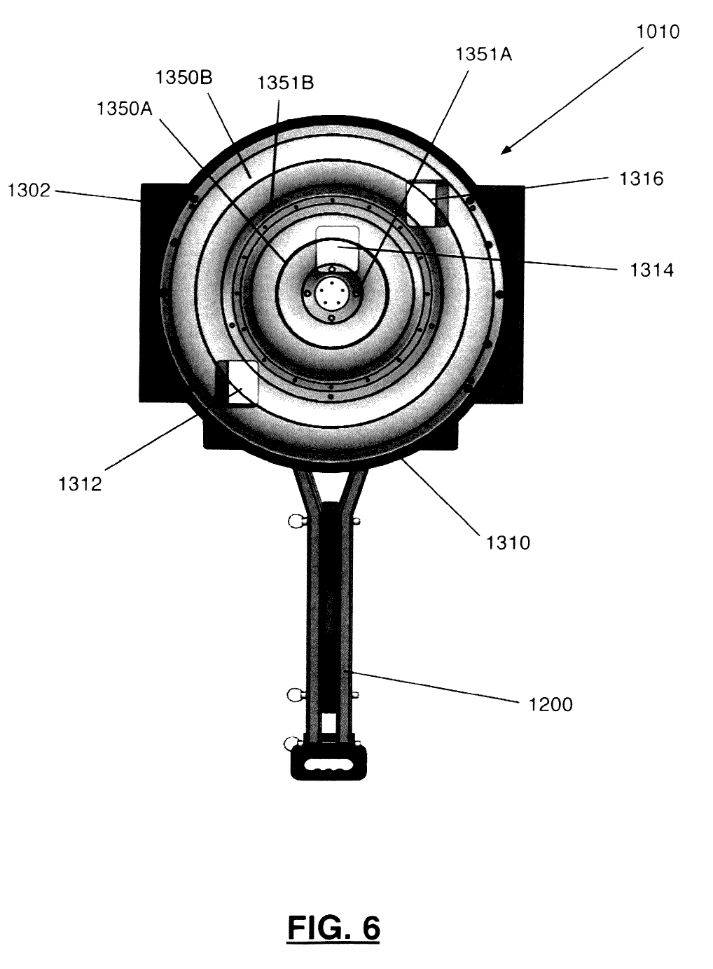

FIG. 6 illustrates another embodiment of a hoverbarrow apparatus 1010 of the disclosure of the present application similar to a wheelbarrow-type device and having a double skirt configuration.

FIG. 6 illustrates the underside of the hoverbarrow apparatus 1010 having the plate member 1310, the torus member 1350A and the torus member 1350B. The plate member 1310 has apertures or inlets 1312, 1316 in fluid communication with the torus member 1350B. The aperture 1314 in the plate member 1310 is in fluid communication with the torus member 1350A. Depending on the need for the distribution of energy required to achieve a uniform lift, apertures 1312, 1316, and 1314 in plate member 1310 can be adapted to be fluid trips thereby creating additional turbulence within the torus member 1350A and the torus member 1350B, respectively.

The torus member 1350A has apertures 1351A and the torus member 1350B has apertures 1351B. Various and sundry types of trips can be used to initiate turbulent flow, and any trip used to initiate turbulent flow or the use of turbulent flow is within the scope of the present disclosure. The trip causes the flow to go from a laminar state to a turbulent state or from a transitional state to a turbulent state.

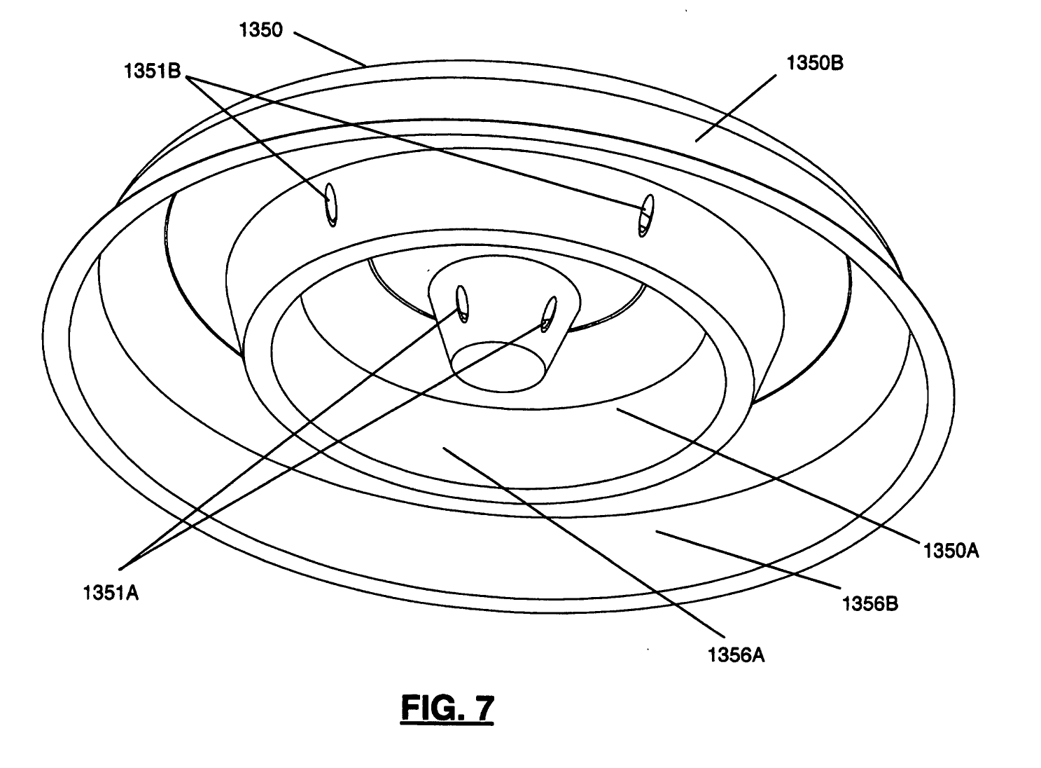

FIG. 7 is a perspective, upper view of one embodiment of the double skirt configuration for the hoverbarrow apparatus 1010 of the disclosure of the present application as illustrated in FIG. 6.

FIG. 7 illustrates the torus member 1350A having the apertures 1351A and the volume 1356A. The torus member 1350B is illustrated having the apertures 1351B and the volume 1356B. The apertures 1351A, 1351B are designed as a “trips” for the fluid. As the fluid passes through the aperture 1351A, 1351B, the trip causes the flow to go from a laminar state to a turbulent state. The trip aperture 1351A, 1351B, as shown in FIG. 7, has an elongated, curved edge. It is appreciated by those skilled in the art that various and sundry types of trips can be used to initiate turbulent flow, and any trip used to initiate turbulent flow or the use of turbulent flow is within the scope of the present disclosure.

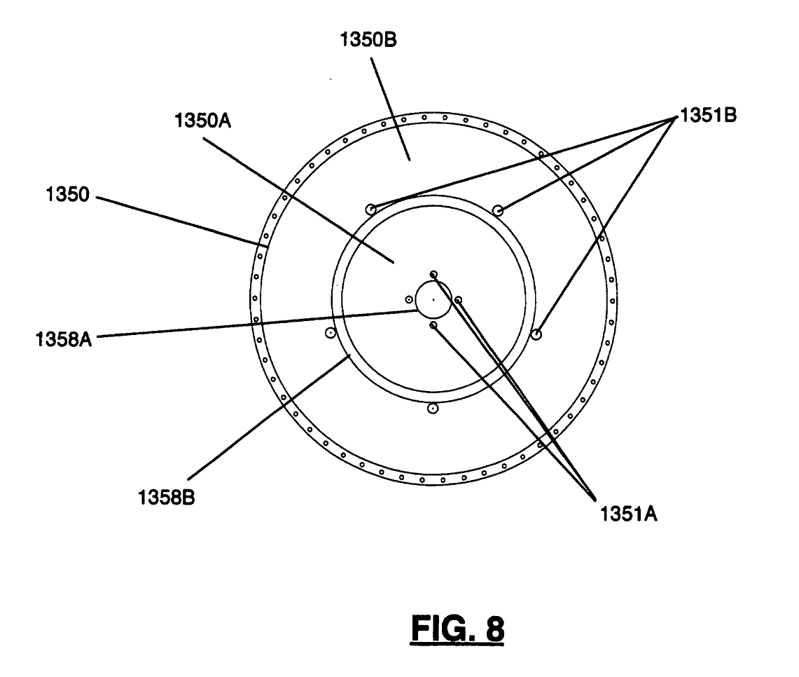

FIG. 8 is a perspective, lower view of the embodiment of the double skirt configuration for the hoverbarrow apparatus 1010 of the disclosure of the present application as illustrated in FIG. 6.

FIG. 8 illustrates the torus member 1350A having the apertures 1351A and the volume 1358A. The torus member 3350B is illustrated having the apertures 1351B and the volume 1358B.

In the another embodiment illustrated in FIGS. 6-8, a barrow apparatus 1010 is provided with a container for accepting material, a fluid mover, and a stabilized conduit for accepting fluid from the fluid mover for systematically and plurally releasing the fluid such that the released fluid provides a film of fluid upon which the barrow apparatus moves with respect to a surface thereby the material in the container is movable to any desired location.

A planar member 1310 is provided in association with the fluid mover. Two or more inlets 1312, 1314, 1316 in the planar member 1310 are for accepting fluid from the fluid mover. Two or more concentric donut shaped, ring torus members 1350A, 1350B are provided for implementing an interior and at least one exterior concentric donut shaped, ring torus members, each having an interior annulus, an exterior annulus and a curved portion in operative association with the surface under the barrow apparatus. The donut shaped, ring torus members 1350A, 1350B are for accepting the fluid from the inlets 1312, 1314, 1316.

The planar member 1310 and the donut shaped, ring torus members 1350A, 1350B define a volume 1356A, 1356B with respect to each donut shaped, ring torus member 1350A, 1350B.

At least one aperture is positioned on the inner annulus of each donut shaped, ring torus member 1350A, 1350B for allowing the fluid to egress therefrom.

The fluid mover places into motion the fluid for passage through the two or more inlets in the planar member for pressurizing the volumes defined by the donut shaped, ring torus members 1350A, 1350B and the planar member. The only mechanism for relieving the pressure in each volume created by the moving fluid is through the at least one aperture positioned on the inner annulus of the donut shaped, ring torus members 1350A, 1350B.

The fluid egressing the at least one aperture in the interior donut shaped, ring torus member 1350A then pressurizes a first exterior volume defined by the exterior surface of the interior donut shaped, ring torus member 1350A and the surface under the barrow apparatus.

The fluid egressing the at least one aperture in the exterior donut shaped, ring torus member 1350A then pressurizes a subsequent exterior volume defined by the exterior surface of the interior ring torus member 1350B, the exterior surface of the interior ring torus member, and the surface under the barrow apparatus 1010.

The surface under the barrow apparatus 1010 creates a steady state, uniform flow of fluid out of the exterior volumes via a gap between each donut shaped, ring torus member 1350A, 1350B and the surface under the barrow apparatus 1010. The gap is caused by the steady state flow of fluid from the exterior volumes around the curved portion of the donut shaped, ring torus members 1350A, 1350B adjacent to the surface for dispersion of the fluid into the atmosphere.

Typically, the barrow apparatus 1010 uses air as the fluid. However it is appreciated that additional fluids may be advantageous in specific situations.

Also, the barrow apparatus 1010 can include a stabilizer member. Further, the barrow apparatus comprises controls for the fluid mover to provide varying fluid flows for maintaining the barrow apparatus 1010 above surface over which it travels. Still further, the barrow apparatus 1010 has a guide member, handle, haft, grip or a combination thereof.

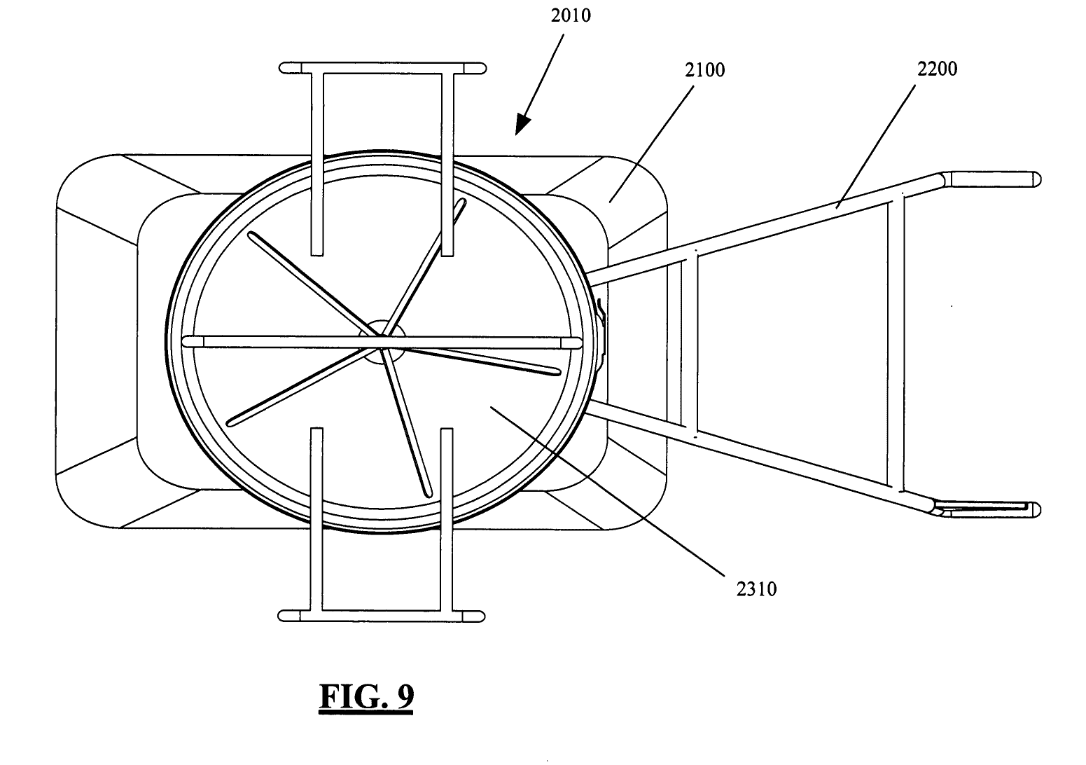

FIG. 9 illustrates a bottom plan view of yet another embodiment of a hoverbarrow apparatus 2010 of the disclosure of the present application similar to a wheelbarrow-type device and having a peripheral skirt configuration.

FIG. 9 shows a container 2100, a handle 2200, and a plate member 2310.

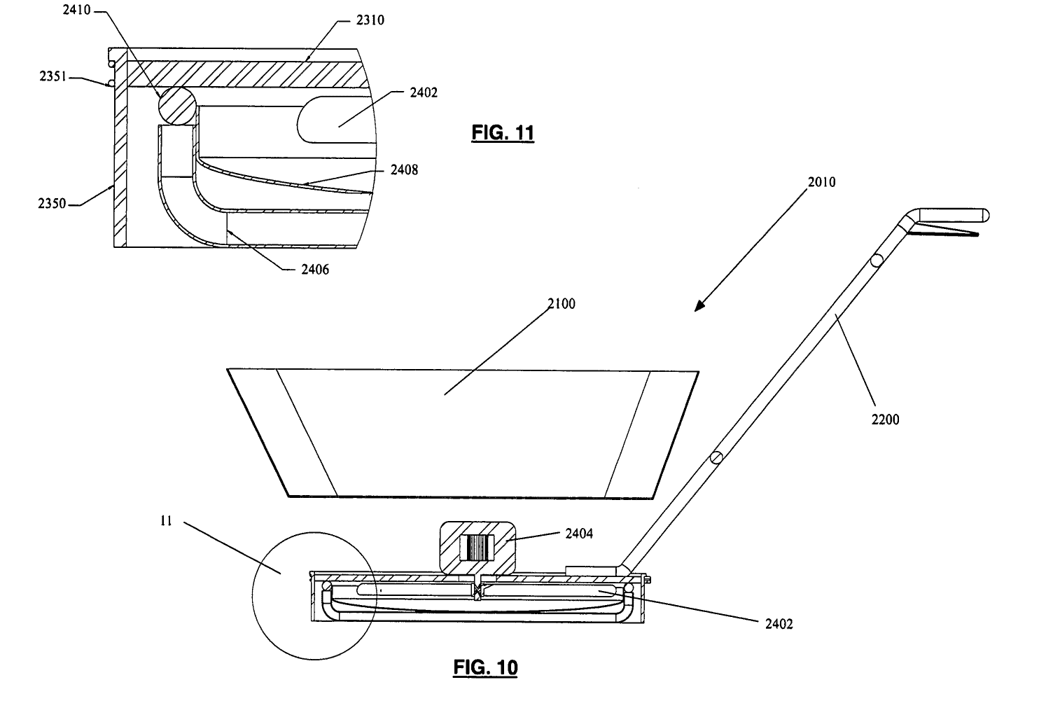

FIG. 10 illustrates an elevation the embodiment of the hoverbarrow apparatus of the disclosure of the present application similar to a wheelbarrow-type device and having a peripheral skirt configuration as illustrated in FIG. 9.

FIG. 10 shows the container 2100, the handle 2200, and the plate member 2310. Also, illustrated is the fan blade 2402, the fan 2404, and the cut-away, blow-up portion 11.

FIG. 11 illustrates a cut-away, blown-up view of the portion 11 of the illustration of the embodiment of a hoverbarrow apparatus 2010 of the disclosure of the present application similar to a wheelbarrow-type device and having a peripheral skirt configuration as illustrated in FIGS. 10.

FIG. 11 shows the plate member 2310, the fan blade 2402, the screen guard 2408, the cross tube base 2406, the top tube frame 2410, the clamp 2351 and the air skirt 2350.

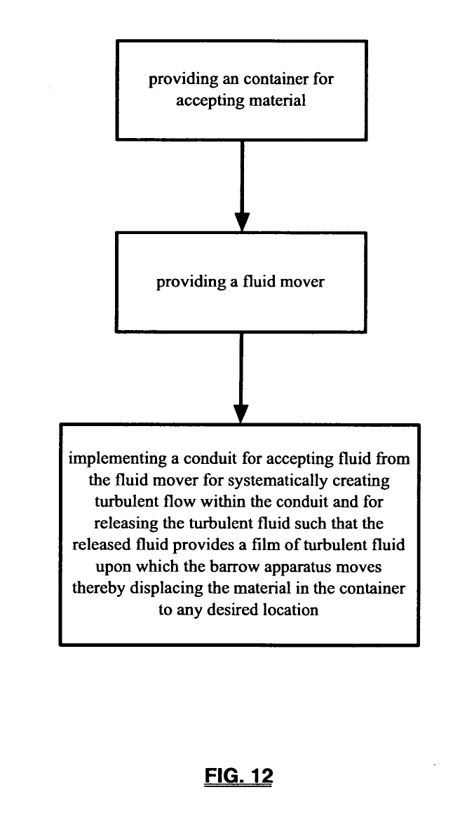

FIG. 12 is a flow diagram illustrating one method of the present disclosure.

A barrow method illustrated in FIG. 12 is provided for using moving material. The barrow method comprises the steps of providing a container for accepting material, providing a fluid mover, and implementing a conduit for accepting fluid from the fluid mover for systematically causing the fluid to be in a turbulent flow state which provides additional energy when the eddies dissipate such that the fluid when released provides a film of significantly higher energy fluid upon which the barrow apparatus moves thereby lifting and/or displacing the material in the container to any desired location.

The barrow method further comprises the steps of providing a planar member in association with the fluid mover, and implementing at least one inlet in the planar member for accepting fluid from the fluid mover.

A donut shaped, ring torus member is provided having an interior annulus, an exterior annulus and a curved portion in operative association with the surface under the barrow apparatus, the donut shaped, ring torus member for accepting the fluid from the inlet. The planar member and the donut shaped, ring torus member define a volume.

The at least one aperture is positioned on the inner annulus of the donut shaped, ring torus member for providing a trip to create turbulent flow and for allowing the fluid to egress for providing a high energy cushion of air.

The fluid mover energizes into motion the fluid for passage of the fluid through the inlet in the planar member for pressurizing the volume defined by the donut shaped, ring torus member and the planar member. The only mechanism for relieving the pressure in the volume created by the moving fluid is through the at least one aperture positioned on the inner annulus of the donut shaped, ring torus member.

The fluid egresses via the at least one aperture for pressurizing a second volume defined by the exterior surface of the donut shaped, ring torus member and the surface under the barrow apparatus.

A steady state, uniform flow of turbulent fluid out of the second volume via a gap between the donut shaped, ring torus member and the surface under the barrow apparatus is created. The gap caused by the steady state flow of turbulent fluid from the second volume around the curved portion of the donut shaped, ring torus member adjacent to the surface provides enhanced lift and disperses the fluid into the atmosphere.

Typically, the barrow apparatus uses air as the fluid. However it is appreciated that additional fluids may be advantageous in specific situations.

Also, the barrow apparatus can include a stabilizer member. Further, the barrow apparatus comprises controls for the fluid mover to provide varying fluid flows for maintaining the barrow apparatus above surface over which it travels. Still further, the barrow apparatus has a guide member, handle, haft, grip or a combination thereof.

While certain exemplary embodiments have been described in details and shown in the accompanying drawings, it is to be understood that such embodiments are merely illustrative of and not devised without departing from the basic scope thereof, which is determined by the claims that follow.

What is claimed is:

1. A barrow apparatus comprising:
a container for accepting material,
a fluid mover, and
a conduit for accepting fluid from the fluid mover for systematically creating turbulent flow within the conduit and for releasing the fluid such that the released turbulent fluid provides a film of fluid upon which the barrow apparatus moves with respect to a surface under the barrow apparatus thereby the material in the container is movable to any desired location.

2. The barrow apparatus of claim 1 wherein at least a portion of the conduit has a ring torus shape.

3. The barrow apparatus of claim 2 wherein the ring torus portion of the conduit has at least one aperture on the ring torus through which the fluid passes causing the fluid to flow around a lowest portion of the torus thereby providing the film of fluid on which the barrow apparatus moves.

4. The barrow apparatus of claim 1 wherein the fluid is air.

5. The barrow apparatus of claim 1 further comprising a stabilizer member.

6. The barrow apparatus of claim 1 further comprising controls for the fluid mover to provide varying fluid flow for maintaining the barrow apparatus above the surface.

7. The barrow apparatus of claim 1 further comprising a guide member, handle, shaft, grip or a combination thereof.

8. The barrow apparatus of claim 1 wherein the conduit further comprises:
a planar member in association with the fluid mover,
an inlet in the planar member for accepting fluid from the fluid mover,
a donut shaped, ring torus member having an interior annulus, an exterior annulus and a curved portion in operative association with the surface under the barrow apparatus, the donut shaped, ring torus member for accepting the fluid from the inlet,
the planar member and the donut shaped, ring torus member defining a volume,
at least one aperture positioned on the interior annulus of the donut shaped, ring torus member for allowing the fluid to egress therefrom,
such that fluid is placed into motion by the fluid mover for passage through the inlet in the planar member for pressurizing the volume defined by the donut shaped, ring torus member and the planar member with the only mechanism for relieving the pressure in the volume created by the moving fluid being through the at least one aperture positioned on the interior annulus of the donut shaped, ring torus member, the fluid egressing the at least one aperture then pressurizes a second volume defined by the exterior surface of the donut shaped, ring torus member and the surface under the barrow apparatus for creating a steady state, uniform flow of fluid out of the second volume via a gap between the donut shaped, ring torus member and the surface under the barrow apparatus, the gap caused by the steady state flow of fluid from the second volume around the curved portion of the donut shaped, ring torus member adjacent to the surface under the barrow apparatus for dispersion of the fluid,
the planar member has a surface partially defining the volume such that the surface is configured to create turbulent flow within the volume defined by the surface of the planar member and the donut shaped, ring torus member.

9. (canceled)

10. The barrow apparatus of claim 8 wherein the surface of the planar member is a sufficiently roughened surface to create turbulent flow.

11. A barrow apparatus comprising:
a container for accepting material,
a fluid mover, and
a conduit for accepting fluid from the fluid mover for systematically creating turbulent flow within the conduit and for releasing the turbulent fluid such that the released fluid provides a film of fluid upon which the barrow apparatus moves with respect to a surface under the barrow apparatus, thereby the material in the container is movable to any desired location, and further comprising
a planar member in association with the fluid mover,
two or more inlets in the planar member for accepting fluid from the fluid mover,
two or more concentric donut shaped, ring torus members for implementing an interior and at least one exterior concentric donut shaped, ring torus members, each having an interior annulus, an exterior annulus and a curved portion in operative association with the surface under the barrow apparatus, the donut shaped, ring torus members for accepting the fluid from the inlet,
the planar member and the donut shaped, ring torus members defining a volume with respect to each donut shaped, ring torus member,
at least one aperture positioned on the interior annulus of each donut shaped, ring torus member for allowing the fluid to egress therefrom,
such that fluid is placed into motion by the fluid mover for passage through the two or more inlets in the planar member for pressurizing the volumes defined by the donut shaped, ring torus members and the planar member with turbulent fluid and the only mechanism for relieving the pressure in each volume created by the moving turbulent fluid being through the at least one aperture positioned on the interior [inner] annulus of the donut shaped, ring torus members,
the turbulent fluid egressing the at least one aperture in the interior donut shaped, ring torus member then pressurizes a first exterior volume defined by the exterior surface of the interior donut shaped, ring torus member and the surface under the barrow apparatus,
the turbulent fluid egressing the at least one aperture in the exterior donut shaped, ring toms member then pressurizes a subsequent exterior volume defined by the exterior surface of the interior ring torus member, the exterior surface of the interior ring torus member, and the surface under the barrow apparatus,
the surface under the barrow apparatus for creating a steady state, uniform flow of fluid out of the exterior volumes via a gap between each donut shaped, ring torus member and the surface under the barrow apparatus, the gap caused by the steady state flow of turbulent fluid from the exterior volumes around the curved portion of the donut shaped, ring torus members adjacent to the surface under the barrow apparatus for dispersion of the fluid.

12. The barrow apparatus of claim 11 wherein the fluid is air.

13. The barrow apparatus of claim 11 further comprising a stabilizer member.

14. The barrow apparatus of claim 11 further comprising controls for the fluid mover to provide varying fluid flows for maintaining the barrow apparatus above surface.

15. The barrow apparatus of claim 11 further comprising a guide member, handle, haft, grip or a combination thereof.

16. A method of moving material using a barrow apparatus, the method comprising the steps of:
providing a container for accepting material,
providing a fluid mover, and
implementing a conduit for accepting fluid from the fluid mover for systematically creating turbulent flow within the conduit and for releasing the turbulent fluid such that the released fluid provides a film of turbulent fluid upon which the barrow apparatus moves thereby displacing the material in the container to any desired location.

17. The method of claim 16 further comprising the steps of:
providing a planar member in association with the fluid mover,
implementing an inlet in the planar member for accepting fluid from the fluid mover,
providing a donut shaped, ring torus member having an interior annulus, an exterior annulus and a curved portion in operative association with the surface under the barrow apparatus, the donut shaped, ring torus member for accepting the fluid from the inlet,
engaging the planar member and the donut shaped, ring torus member for defining a volume,
providing at least one aperture positioned on the interior annulus of the donut shaped, ring torus member for allowing the fluid to egress therefrom,
energizing the fluid into motion by the fluid mover for passage of the fluid through the inlet in the planar member for pressurizing the volume defined by the donut shaped, ring torus member and the planar member with the turbulent fluid and only mechanism for relieving the pressure in the volume created by the moving turbulent fluid being through the at least one aperture positioned on the interior annulus of the donut shaped, ring torus member,
egressing the turbulent fluid via the at least one aperture for pressurizing a second volume defined by the exterior surface of the donut shaped, ring torus member and the surface under the barrow apparatus,
creating a steady state, uniform flow of turbulent fluid out of the second volume via a gap between the donut shaped, ring torus member and the surface under the barrow apparatus, the gap caused by the steady state flow of turbulent fluid from the second volume around the curved portion of the donut shaped, ring torus member adjacent to the surface under the barrow apparatus for dispersion of the fluid.

18. The method of claim 16 further comprising the step of stabilizing the barrow.

19. The method of claim 16 further comprising the step of controlling the magnitude of the turbulence to provide varying energy dissipation for controlling the lift of the barrow apparatus above the surface.

20. The method of claim 16 further comprising the step of implementing a guide member, handle, haft, grip or a combination thereof.
